(19) United States
(12) Patent Application Publication
(10) Pub. No.: US 2005/0159973 A1
(43) Pub. Date: Jul. 21, 2005

(54) Method and system for computerizing quality management of a supply chain

(75) Inventors: Rainer Krause, Kostheim (DE); Christian Waldenmaier, Pforzheim (DE); Udo Kleemann, Stakecken-Elsheim (DE); Michael Kaltenbach, Mainz-Kostheim (DE); Thomas Fleck, Klein-Winternheim (DE)

Correspondence Address: Intellectual Property Law;IBM Corporation, Dept. 18G, Building 300-482, 2070 Route 52, Hopewell Junction, NY, 12533, US

(73) Assignee: International Business Machines Corporation, Armonk, NY (US)

(21) Appl. No.: 11/022,450

(22) Filed: Dec. 22, 2004

(30) Foreign Application Priority Data
Dec. 22, 2003 (DE) 03104920.8

(51) Int. Cl. G06F 17/60

(52) U.S. Cl. 705/1

(57) ABSTRACT

A system handling fully automated supplier quality control and enabling quality improvement by using supplier raw data as well as manufacturer manufacturing in-line data is described. The system not only maintains fully automated data transfers and handling, but also enables immediate automated reporting for both the manufacturer and the supplier. Based on this automated notification, communication between sides is thus introduced. The system also enables the transfer from reactive into preventive working mode, concerning supplier quality, giving advantages like early warning, fast feedback. Beyond the so-called automated quality control features, the system supports quality improvement enabling advanced analysis features like yield prediction, specification validation, best of breed analysis, and the like. These capabilities include a close feedback control loop with an adaptation feature to correct the prediction in case of a deviation and/or trend. The advanced features require the link to the supplier quality data with the manufacturer manufacturing data, to be able to use history data for ongoing analysis and prediction.

### BACKGROUND OF THE INVENTION

The present invention generally relates to supply chain management, and in particular to a computerized method and system to provide quality management in a supply chain environment including components shipment.

Today suppliers provide data typically with the component shipment as hardware components, e.g., those to be used thereafter for assembling a hardware apparatus. Such as a magnetic hard disk drive (HDD) or any other mechanic and/or electronic device. The above mentioned hardware components typically are provided to the manufacturer for their use for manufacturing, i.e., processing or assembling hardware based on these components by means of a supply chain.

In such a supply chain scenario it is known from replenishment system (RSC) disclosed in U.S. patent application Ser. No. 10/163038, of common assignee, which is hereby incorporated by reference, to manage the replenishment of this provision by all participants of the entire supply chain applicable to the manufacturer, using a so-called “Replenishment Service Center Network” (RSC@). RSC describes a method and system for the logistic management of the supply chains of digitally networked suppliers, wherein supply chain participants that are linked directly within the supply chain are identified and grouped. Further, on the side of each of the grouped supply chain participants, logistic requirements for fulfilling local supply activities to other supply chain participants of the group are determined, and logistic information between those two supply chain participants is exchanged, and the local logistic requirements on the side of each of the grouped supply chain participants depends on the contents of said exchanged logistic information controlled. This approach enables a decentralized management with considerably less efforts than the prior art approaches, wherein the collaboration and replenishment between collaborating suppliers is accomplished by computer network such as Internet.

Although the delivery or shipment of such components of a product to be manufactured by a product manufacturer has many advantages, (such as the increased flexibility in acquiring components from several component suppliers, which improves, e.g., the cost management), a corresponding supply chain management, on the other hand, has the disadvantage that quality data cannot be screened until the related components or parts thereof are already in a vendor managed inventory (VMI) or in an underlying manufacturing or in the processing line. Quality data does not receive the product manufacturer on-line which implies that the data transfer within an entire quality value chain is rather complicated.

Referring now to FIG. 1, the basic principles of the underlying prior art Replenishment Service Center network (RSC@) environment are illustrated. Shown therein is a computer-implemented system for managing a supply chain as described in U.S. patent application Ser. No. 10/163038. The supply chain consists of a supplied company 200, preferably a product manufacturer, and a number of suppliers referenced A-C 204-206. The entire supply chain hereby is managed using Internet 208 as the communication channel outside the supplied company 200 and using a proprietary intranet 210 inside the supplied company 200.

On the supplied company 200 side, the whole supply chain is managed using an internal Lotus Notes™ (in the following “LNotes”) server 212 that is connected to an SAP™ server 214. The SAP server 214 is used to manage the whole supply chain on an administrative level, wherein LNotes server 212 is used to communicate with an external LNotes server 216 that is used to manage the necessary communication between the supplied company 200 and the suppliers 202-206 and the communication between grouped suppliers as described above. Between internal LNotes server 212 and external LNotes server 216, preferably, a firewall 218 is arranged in order to secure the supplied company 200 intranet 210 against unauthorized accesses from outside.

The SAP server 214, in particular, transmits release order information to internal LNotes server 212. According to the invention, it additionally delivers replenishment forecast information to the internal Lnotes server 212 which is then transferred to suppliers 202-206. Outside the intranet of the supplied company 200, the external LNotes server 216 is interconnected with each of the suppliers 202-206 via Internet 208. In addition, the external LNotes server 216 is connected to the above mentioned Replenishment Service Center (RSC) 220 which again is connected to a factory 222 for assembling devices for the supplied company 200 using modules or parts obtained from the suppliers A-C 202-206. These modules or parts are physically transported from each supplier A-C 202-206 to RSC 220 and the factory 222 via common transport channels 224 like known transport service companies.

The assembled devices are finally transported from the factory 222 to the supplied company 200 via another transport channel 226, designated herein as “physical goods transfer channels”” Physical transportation of the modules and the assembled devices is managed using a freight server 228 that is connected to the RSC 220 via data lines 230.

### SUMMARY OF THE INVENTION

It is therefore an object of the invention to provide an improved method and system to achieve a high quality management in a supply chain environment.

According to a first aspect of the invention, there is provided a method of managing quality in a production facility where products are manufactured using components, the method including the steps of: a)receiving quality data for incoming components; b) analyzing the received quality data on the basis of history quality data collected from prior received components and history data collected during processing the prior received components in the production facility; c) predicting the influence of the quality of incoming components on the yield of the production facility; and d) selecting components in accordance with the prediction.

According to a further aspect of the invention, there is provided a computer system for managing quality in a production facility where products are manufactured using components, the system including: a) means for receiving quality data for incoming components; b) means for analyzing the received quality data on the basis of history quality data collected from prior received components and history data collected during processing the prior received components in the production facility; c) means for predicting the influence of the quality of incoming components on the yield of the production facility; and d) means for selecting components in accordance with the prediction.

The invention achieves component traceability through the entire chain by way of parameter/yield functions as well as related correlations. The functional (technical) correlation between a read/write (r/w) head of a magnetic disk of an HDD and the magnetic disk (media) itself can be used in order to enhance their inter-operability, using actual and history quality and logistics data. In this way, improvements of r/w head and media interoperability can be achieved by dedicated component selection.

Data analysis is performed based on automatically provided parametric raw data of each part of the final assembly or device. These parametric data include but not limited to functional or dimensional parameters as well as cleanliness and other process parameters. The data analysis enables calculating the quality trends and determines possible part specification violations at a very early stage of the supply chain.

The present invention represents a collaborative approach of the manufacturer and each supplier of a supply chain who will dynamically cooperate in order to provide improved quality and enable yield prediction, particularly along all channel or paths of the entire supply chain. The collaborative approach particularly ensures that both the supplier and the manufacturer view the same issues, reports and charts and methodology from a common viewpoint. Utilizing the aforementioned yield prediction, the invention enables a reactive and preventative (dynamic) quality management where quality visibility is given through the entire supply chain, even timely ahead of the shipment.

The managing approach of the invention enables a fully automated data transfer and handling, and the like, an immediate reporting in both directions between the corresponding manufacturer and the supplier, including automated notification which forces communication and an early warning and fast feedback. As a result, the approach provides a fully automated and modularly structured as well as a very reliable quality management in the supply chain even if complex products consisting of a large number of components or parts are manufactured. In particular, quality aspects are made visible through the entire quality value chain and, thus, an advanced quality control and improvement.

Finally, the present management approach also provides data to improve the specification requirements for the components or parts being supplied.

### BRIEF DESCRIPTION OF THE DRAWINGS

Referring now to the accompanying drawings, the invention is described in more detail by way of preferred embodiments from which further features, aspects and advantages become evident, in which:

FIG. 1 shows the prior art Replenishment Service Center network (RSC@);

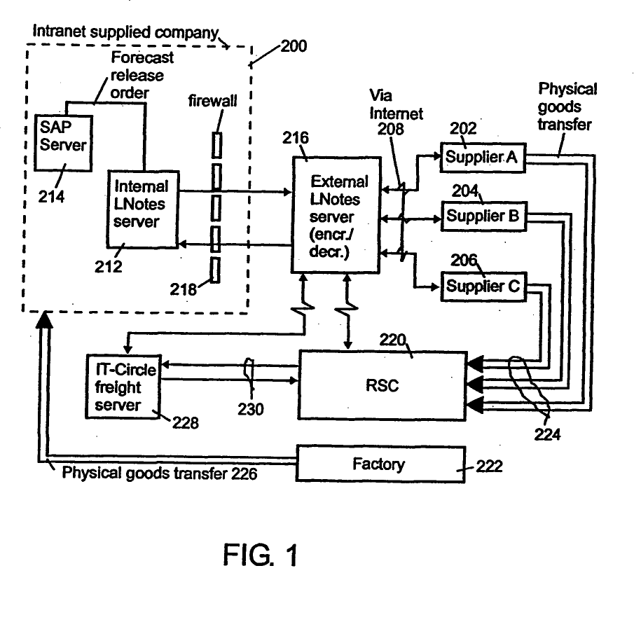

FIG. 2 shows a diagram of a typical process flow of a quality management process (SQUIT quality control process) according to the present invention;

FIG. 3 shows a diagram of a typical data analysis flow of the quality management process of the present invention;

FIG. 4 shows typical parameter versus yield function diagram determined by way of data mining, including offset and slope as well as correlation value;

FIG. 5 depicts an overview flow diagram of an advanced algorithm (module) according to the invention, particularly including input parameters;

FIGS. 6A-6B illustrate typical mean shift of parameters of supplied interfering components (FIG. 6A); and the correction of the above mean shift by yield prediction and dedicated pull analysis, according to the invention (FIG. 6B);

FIG. 7 is a schematic diagram illustrating dedicated pull of supplied components to achieve quality matching and enhanced overall yield in accordance with the invention;

FIG. 8 illustrates a link of quality and logistic flow by way of flow diagram according to the invention; and

FIG. 9 shows a preferred IT architecture of a SQUIT system according to the invention.

### DETAILED DESCRIPTION

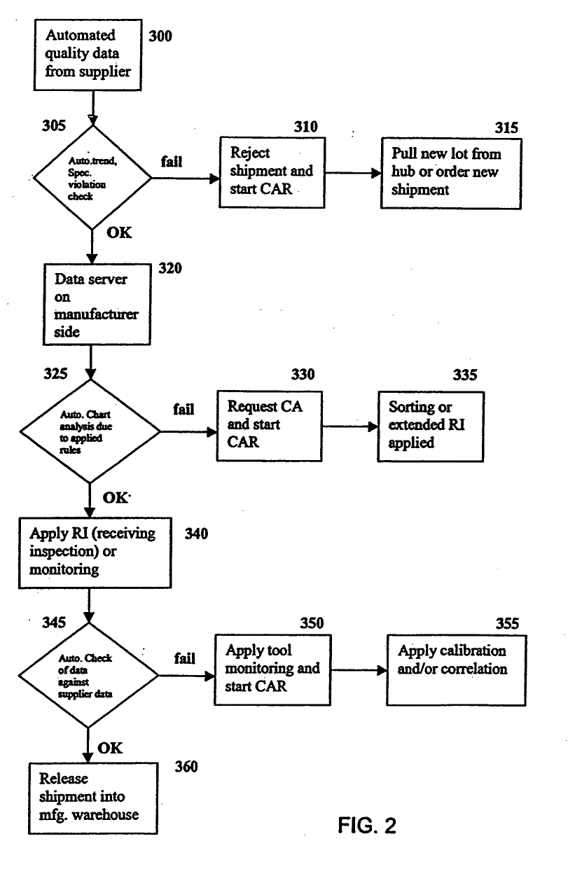

Referring now to FIG. 2, there is shown a preferred process flow of the SQUIT process according to the present invention.

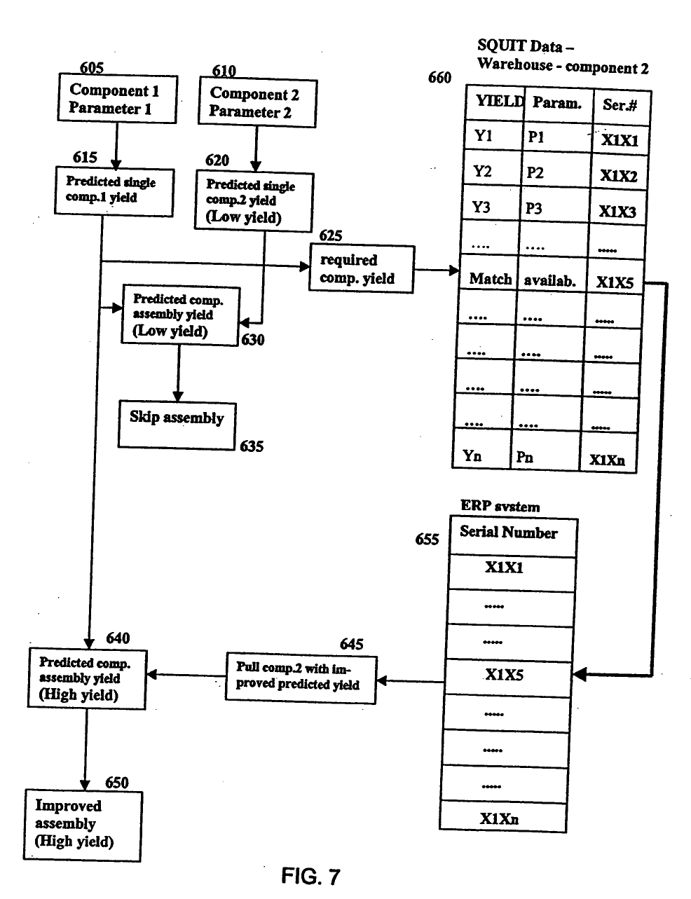

In first step 300 of the depicted SQUIT process, quality related data is gathered from a supplier in an automated manner. The supplier and the manufacturer both use the same data table structures to transfer and report these quality data. In order to enable the data flow shown, data sets consisting of raw data is collected during the manufacturing process. The supplier needs to provide additional information, such as serial number, part number, process dates and other logistical data required to enable full traceability of the part being manufactured and the delivery processes of the chain (FIG. 7).

In the following step 305, raw quality data that was gathered is checked automatically against existing specification limits, preferably being kept on the side of the manufacturer. Violations are reported automatically both to the supplier and to the manufacturer at the same time when the RSC@ application is activated with appropriate actions, like a shipment stop and the like.

In case the violation check 305 fails, the shipment of the corresponding part is rejected and a supplier improvement request (CAR) module is initiated 310. Then, a new lot is extracted from the parts vendor managed inventory (VMI) or from the supplier owned vendor managed inventory (VMI), if available, or from a new shipment being ordered 315. If the result of the violation check 305 is positive (‘OK#), i.e., no violation is revealed, and the quality data is transferred 320 to a data server located on the manufacturer side. At the data server, an automatic chart analysis is conducted 325 based on certain rules. Rules can be, e.g., trend analysis, preferably, while applying any type of, e.g., Western Electric rules or other customized rules, as well as means for a shift analysis or even a specification validation analysis. If the chart analysis fails, a Corrective Action (CA) is requested and a supplier improvement request (CAR, corrective action request) module is initiated 330. Then, the quality data is sorted and a receiving inspection (RI) is applied to the data 335.

If the chart analysis 325 reveals that the quality data fulfills the above mentioned rules, then only the aforementioned RI is applied, if no supplier data confidence level is reached, or if further monitoring on the quality data is to be conducted 340. In next step 345, the quality data is checked automatically against the corresponding supplier data. If the check fails, a tool monitoring is applied and the CAR module is initiated 350. In case where RI is applied, i.e., not enough history data base or data confidence to the supplier data exists, the RI data is additionally giving the advantage of controlling the tool correlation between the supplier and the manufacturer. If the data shows a deviation (345—fail), it may imply that some measurement tool either at the supplier or at the manufacturer is running out of control. In the following step 355, calibration and/or correlation is applied on the measurement tool using, if it was already ensured 350 that the correlation between the measurement tools is off. The quality data is used to match the corresponding supplier data. If the check 345 against the supplier data reveals to be normal, then the shipment of the underlying components or parts thereof to the manufacturer warehouse is released 360.

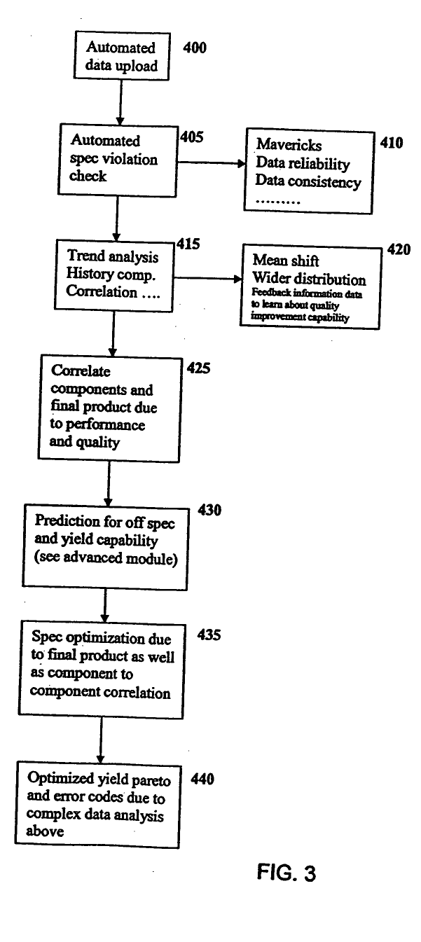

In FIG. 3 the above mentioned SQUIT data analysis flow is described in more detail by way of a flow chart. The flow chart begins with an automated data upload 400 of the mentioned quality data to the data server located, preferably on the side of the manufacturer. Then, an automated specification violation check is conducted 405. If the check 405 fails, then the underlying components or parts are marked 410 “out-of-spec”, and/or single mavericks which may be caused by a wrong data upload, typos, incase of manual insert, and the like are eliminated. If the check 405 reveals no spec violation of the underlying component or part thereof, then a trend analysis and correlation based on previous components (providing history data) are performed 415. If the analysis 415 reveals a negative trend, then in step 420 the mean shift of the distribution of the corresponding property of the component/part is adapted and potential quality improvement capabilities are learned by way of recurring feedback of quality information. Otherwise, the following step 425 is executed wherein the components and the final product are correlated in view of product performance and quality.

In the following step 430, a prediction of off-spec behavior and yield capability are performed using the aforementioned advanced module. The spec optimization due to the final product and component-to-component correlation is performed 435. In the final step 440 of the present analysis flow, advanced analysis results including spec validation are used to generate an improved yield and a better understanding of underlying error codes, by phasing in higher quality components and matching quality to manufacturing, as well as preventing phasing in failing parts by a prediction analysis.

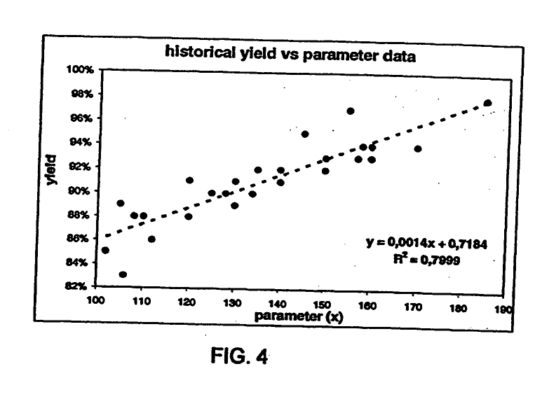

FIG. 4 shows an illustrative exemple of the yield y as a function of a part or product related parameter p in linear form y=f(p)=a*p+b (wherein a is the slope and b is the offset). This functional dependence of the yield is used by an advanced algorithm as well as the correlation value (R\hat{ }2) described in more detail hereinafter. The distribution of the dots showing in y direction illustrates a typical normal yield distribution. It is worth noting that the underlying parameter function can be, instead of the aforementioned linear function, e.g., a square function or any other function.

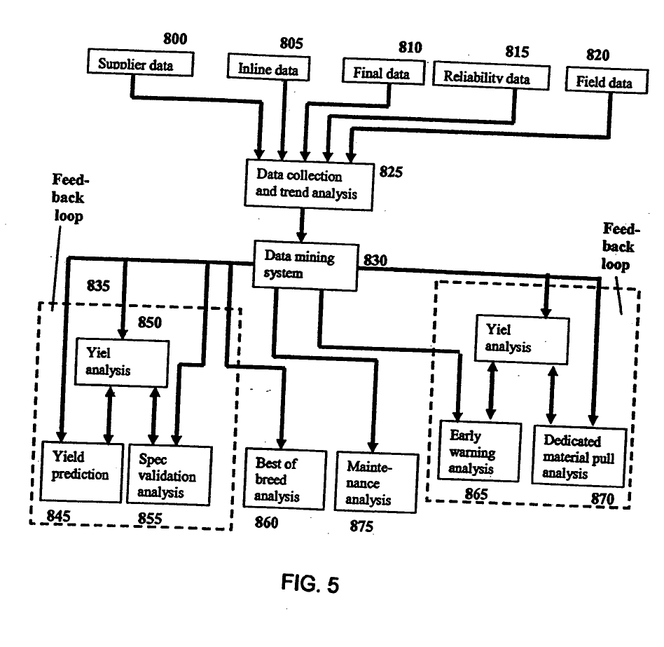

FIG. 5 illustrates the information input to the quality management system, according to the invention, which includes supplier data 800, in-line data 805, final data 810, reliability data 815 and field data 820. This data is collected and subjected to the aforementioned trend analysis and spec violation analysis 825 in order to enable early warning. The output of the trend analysis 825 is transferred to the aforementioned data mining module 830 for determining the functions and related correlation values (Feedback loops 835, 840). The above input parameters are used to conduct yield prediction 845, yield analysis 850, spec validation analysis 855, best of breed analysis 860, early warning 865, dedicated pull 870, and maintenance analysis 875.

The input quality related data provided by the component supplier is subjected to a quality control by way of, e.g., Western Electric (WE) rules and performing spec violation check against given specification limits for parameters of these components. An exemplary parameter includes impurity of a silicon bulk substrate. If the trend analysis and violation check do not display quality issues for the component supplied, then the data is only stored for history reference described hereinafter, as previously described by way of FIGS. 2 and 3. The input data, in addition, is ollected and stored in a SQUIT data warehouse.

The manufacturing process data (in-line and final) is linked to the SQUIT data warehouse in order to determine parameter yield functions and related correlation values using the data mining module 830. In this way, field and reliability data can be used to accelerate failure analysis efforts under warranty conditions.

By means of the data mining module 830, a yield analysis is performed 850. For single parameters, the yield analysis is used, in conjunction with parameter yield function and correlation value, to predict the yield for the related component 845.

Using again the raw parameters, the functions, correlation values and yield analysis enables to validate 855 the specification of the underlying component.

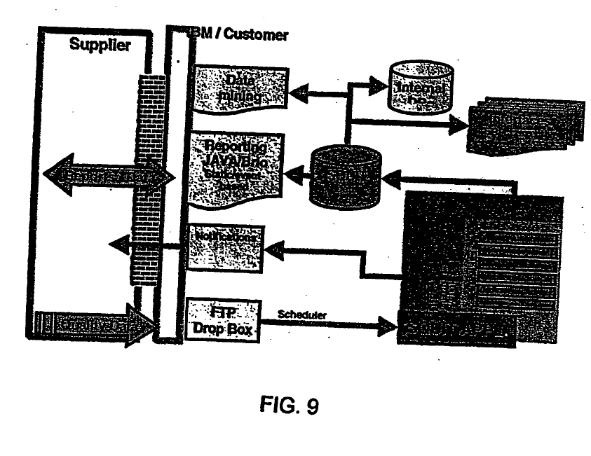

To secure appropriate prediction and validation, a closed control loop is applied to control and adjust 835 the prediction algorithm described hereinafter, adaptively. As depicted in FIG. 9, it requires a link to the parametric quality data with the related logistic data. The aforementioned early warning capability 865 is realized using yield analysis and parameter yield functions. The same is valid for dedicated material pull analysis 870. Data mining module 830 provides an output for the best of breed and for preventive maintenance analysis.

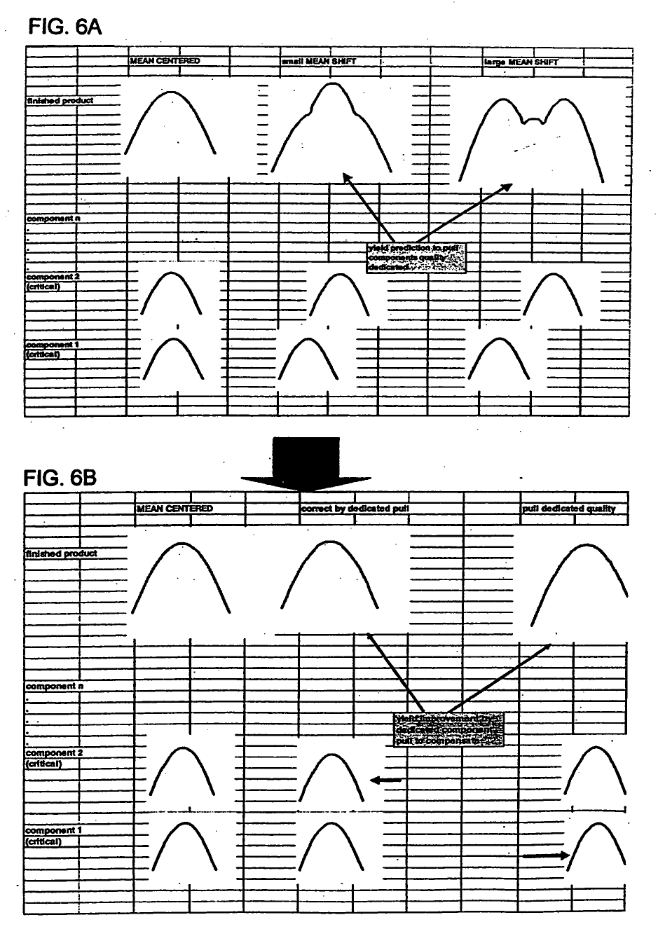

FIG. 6A shows three different distributions of two interacting components (lower part) as well as the superposition of these distributions (upper part). The left-hand distribution shows two mean-centered distributions within specification. The middle and right-hand Figures show two mean-shifted component distributions where the single distributions are within spec and wherein the two superpositions are partially out-of-spec. It must be emphasized that a single in-spec component can cause an assembled out-of-spec function.

FIG. 6B shows how the present SQUIT system improves quality despite mean-shifted components distributions by way of the aforementioned pulling to match the quality of the two components, taking into account that the superposition distribution is still mean-shifted but the distribution width of the assembly (superposition) is significant lower.

FIG. 7 shows a dedicated pull example for matching quality requirements to improve the assembled yield. In case of an assembly of two interfering components (605 and 610), the system enables a yield optimization. If, e.g., randomly extracted component 2 impacts lowering the yield of the assembled item (615-635), then a parameter matching component 2 to the existing component 1 can be found (640-650 and 660) using the predicted yield, a related parameter as well as serialization from the SQUIT data warehouse linked to the ERP system (655).

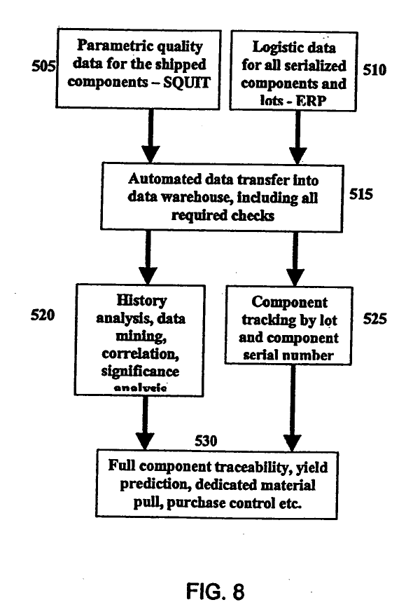

FIG. 8 depicts the data flow linking quality and logistic while quality and related logistic data is provided by the SQUIT module (505). A data connection to the vendor managed inventory (VMI) is realized by means of an underlying Enterprise Replenishment Planning (ERP) solution (510), e.g., SAP/R3. A data link between the two systems (515) enables the aforementioned full traceability and dedicated pull (520-530) as well as a closed control loop.

FIG. 9 depicts a schematic IT architecture of the present collaborative solution showing supplier as well as manufacturer site separated by firewall. Supplier responsibility to upload parametric raw data into the above described SQUIT system. The manufacturer is responsible for feeding back the data and reporting to the supplier, preferably, in a collaborative mode. Furthermore, the SQUIT application retrieves the supplier-provided data and performs the above described spec validation, trend yield analysis and collaborative reporting. Moreover, the system is linked to other internal data bases and is provided with interfaces to other IT solutions, e.g., ERP, shop floor control or CARs.

The mathematical background for the proposed algorithms for yield prediction, and the like, is described hereinafter in more detail.

Advanced features of SQUIT enable full automation and transfer from reactive into preventive quality mode using a collaborative effort between suppliers and customer and free data and information exchange. The automated notification feature has the advantage of forcing communication between suppliers and customers. The IQM algorithm described below, enables highly advanced data analysis using the trend and data mining results. It results in an improvement in quality, yield and cost.

1. Advanced Analysis for Yield Prediction Using History Data

Definitions:
CF_{ay}: correlation factor between a parameter and yield
Fₐ: function describing relation between yield and parameter a
   Fₐ=sₐ*xₐ+oₐ
s: slope (known from history data)
o: offset (known from history data)

In case of n critical parameters for yield performance, the yield depends, due to correlation, on each single parameter. Final yield depends on all critical parameters:
F_{f}=F₁=F₂=F₃= . . . Fₙ
The critical parameter yields combined additive using the correlation factors and a transformation factor to determine the final yield based on all participating individual functions and parameters.
1.1 Predicted Yield Algorithm:

$${F}_{f} = {t}_{1} * {CF}_{1} * {F}_{1} + {t}_{2} * {CF}_{2} * {F}_{2} + {t}_{3} * {CF}_{3} * {F}_{3} + … + \\ {t}_{n} * {CF}_{n} * {F}_{n} = {\sum }_{i = 1}^{n} {t}_{i} * {CF}_{i} * {F}_{i} \\ {F}_{f} = \{ [ {\sum }_{i = 1}^{n} {t}_{i} * {CF}_{i} ] * {F}_{f} \} / n \to [ {\sum }_{i = 1}^{n} {t}_{i} * {CF}_{i} ] = n \to \\ [ {\sum }_{i = 1}^{n} {CF}_{i} ] = n / t \qquad ( 1.1 )$$

t is a generic transformation factor determined by the sum of all correlation factors.

Each single parameter can be used to determine the final yield predictive:

$$\begin{matrix}{F}_{f} = {t}_{1} * {CF}_{1} * ( {s}_{1} * {x}_{1} + {o}_{1} ) + {t}_{2} * {CF}_{2} * ( {s}_{2} * {x}_{2} + {o}_{2} ) + {t}_{3} * {CF}_{3} * ( {s}_{3} * {x}_{3} + {o}_{3} ) + … + {t}_{n} * {CF}_{n} * ( {s}_{n} * {x}_{n} + {o}_{n} ) \\ {F}_{f} = \{ [ {\sum }_{i = 1}^{n} {t}_{i} * {CF}_{i} * ( {s}_{i} * {x}_{i} + {o}_{i} ) ] \} / n = \{ [ {\sum }_{i = 1}^{n} {CF}_{i} * ( \underbrace{{s}_{i} * {x}_{i} + {o}_{i}} ) ] * t \} / n ← \text{PREDICTED YIELD} & ( 1.2 ) \\ = F ( x ) \text{(any function of parameter possible,} & \\ \text{not only linear fit)} & \end{matrix}$$

(the history data delivers function parameters with slopes (sᵢ) and offsets (oᵢ) as well as correlation factors (CFᵢ) and transformation factor (t), recent data reflects the xᵢ-parameters)
2. Best of Breed Analysis Using History Data

For the quality parameters and yields, critical parameters are used (see yield prediction). The quality parameters are compared against the upper and lower specification limits, could be also x+3σ and x−3σ, full distribution width (±3σ), around mean value (x). The ranking factors are determined with the correlation factors (see yield prediction).

Quality parameter limits:
pᵢ=x=1, pᵢ=x′3σ=x−3σ=0
F(p)=0 if p=x+3σ if p=x−3σ and F(p)=1 if p=x
2.1 Single Quality Parameter pᵢ
If pᵢ≦x:
F(p)=(pᵢ/3σ)−[(x−3σ)/3σ]=[(pᵢ−x+3σ)/3σ]
If pᵢ≧x:
F(p)=[(x+3σ)/3σ]−(pᵢ/3σ)=[(x+3σ−pᵢ)/3σ]

Quality parameters range between 0 and 1 (normalized) within the 3σ limits, for all n parameters.

$$\begin{matrix}F ( p ) = [ {\sum }_{i = 1}^{n} ( {p}_{i} - \underline{x} + 3 σ ) / 3 σ ] / n & ( 2.1 ) \\ if {p}_{i} \leq \underline{x} & \\ F ( p ) = [ {\sum }_{i = 1}^{n} ( \underline{x} + 3 σ - {p}_{i} ) / 3 σ ] / n & ( 2.2 ) \\ if {p}_{i} \geq \underline{x} & \end{matrix}$$

Multiple quality parameter algorithm using eq. 2.1 and 2.2 and weighting by correlation value:

$${F ( p )}_{t} = [ {\sum }_{i = 1} F ( {p}_{i} ) * {CF}_{i} ] / n \qquad ( 2.3 )$$

CFᵢ: correlation factors for the different parameters to total yield, see equation (1.1)
F(pᵢ): normalized quality parameters from equations (2.1) and (2.2)

This parameter F(p) ranges between 0 and 1, where 1 reflects best and mean centered performance. If the parameter is significant below 1, an engineer on the customer side must work closely together with the supplier to improve the quality and in case request a CA (corrective action).

2.2 Component Cost

Compare target cost (cₜ) to actual cost (cₐ) for all components.

If the cost parameter is >1 no action required, because the actual cost is better than the target cost.

If the cost parameter is <1, the supplier engineer on the customer side must work together with the supplier to improve.

$${c}_{p} = {c}_{t} / {c}_{a} \qquad ( 2.4 )$$

This parameter cₚ is also in a range between 0 and 1, while 1 (or may be even >1) reflects that supplier meets or exceeds cost target.

2.3 Yield Performance

Yield parameter (yₚ) is determined by the target yield (yₜ) and the actual yield (yₐ).

$${y}_{p} = {y}_{a} / {y}_{t} \to {y}_{p} = [ {\sum }_{i = 1}^{n} ( {y}_{ai} / {y}_{ti} ) ] / n \qquad ( 2.5 )$$

If the yield parameter is >1, no action is required because the actual yield is better than the target yield. If the averaged yield parameter is <1, it indicates a quality problem. CA and supplier engineer action is required.

2.4 Cost Impact (Yield and Rework)

The estimated rework (r_{c}) and scrap (s_{c}) cost due to fails reflected by the yield or in-line rework are used. Yield is reflected by the number of rework (nᵣ) and the number of scraps (nₛ). Additionally, the in-line rework numbers (nᵢᵣ) must be considered. The SFC system provides a first time (y_{ft}) and final yield (y_{f}), the difference being the final rework, and the final yield reflects scrap number. The SFC system also delivers the numbers for in-line scrap (nᵢₛ) and in-line rework (nᵢᵣ).

Total build (nₜ) and final yield delivers the number of scraps: nₛ=nₜ*(1−y_{f})

Total build, first time and final yield delivers the number of reworks: n_{f}=nₜ*(y_{f}−y_{ft})

Overall cost impact: o_{c}=(nᵣ+nᵢᵣ)*r_{c}+(nₛ+nᵢₛ)*s_{c}

Normalized cost impact using total build:

$${n}_{c} = [ ( {n}_{r} + {n}_{ir} ) * {r}_{c} + ( {n}_{s} + {n}_{is} ) * {s}_{c} ] / [ ( {r}_{c} + {s}_{c} ) * {n}_{t} ] \qquad ( 2.6 )$$

The cost impact parameter is most likely <0.1 due to low rework and scrap numbers. Therefore, this parameter may be ranked higher to compensate this against the other parameters, which are typically 10 times higher. Finally, it is to be adjusted with the experience of its history.

2.5 Shipment Performance

The shipment performance (sₚ) of the real shipment date (sᵣ) for each individual supplier is measured against ship performance from commitment (s_{pc}) and target (sₚₜ), using ship commitment (s_{c}) and ship target (sₜ) dates. The shipment dates are measured either after PO, or commitment send. The individual count would be in days, for all measured ship date criteria.

Ship performance versus commitment:
sp=1+(s_{c}−sᵣ)/s_{c}

Ship performance versus target:
sₚₜ=1+(sₜ−sᵣ)/sₜ

Overall ship performance:

$${s}_{p} = ( {s}_{pc} + {s}_{pt} ) / 2 \qquad ( 2.7 )$$

2.6 Best of Breed Parameter Algorithm

Each of the parameters used must receive a ranking (r₁ . . . r₅) in accordance with its importance in order to achieve the overall best of breed evaluation. All parameters range between 0 and 1. The ranking factors are inserted by a supplier quality engineer or by a procurement engineer.

$$BOB = [ {r}_{1} * {F ( p )}_{t} + {r}_{2} * {c}_{p} + {r}_{3} * {y}_{p} + {r}_{4} * nc + {r}_{5} * {s}_{p} ] / 5 \qquad ( 2.8 )$$

Beast of Breed (BOB) is to be determined for each supplier and compared to each other.

3. Pull Dedicated and Matching Quality from Hub/Warehouse

This feature requires the link with the logistic data. To get matching component performance the correlations between interfering components have to be considered. These correlation numbers have to be provided by the data mining tool. The yield prediction in accordance with equation (1.2) determines, in the case of low yield indication for the single component, whether the matching component analysis should be applied. Analyze interfering components due to the yield variation based on both parameters (3D plot). Yield has a dependency to significant and correlating parameter of component 1 as well as component 2.
Total Yield yₜ=F(p₁)=F(p₂)=a₁*p₁+b₁=a₂*p₂+b₂
yₜ′=F(p₁′)=F(p₂′)=a₁′*p₁+b₁′=a₂*p₂′+b₂′

Yield function in dependence of both component parameters are as follows:

$${F}_{t} = F ( {p}_{1} ) * F ( {p}_{1}^{′} ) = F ( {p}_{2} ) * F ( {p}_{2}^{′} ) \to \\ {F}_{t} = [ {\sum }_{i = 1}^{n} {a}_{i} * {p}_{i} + {b}_{i} ] * [ {\sum }_{j = 1}^{m} {a}_{j} * {p}_{j} + {b}_{j} ]$$

Parameter evaluation:

$$\begin{matrix}{p}_{1}^{2} + [ ( {ab}^{′} + {ba}^{′} ) / {aa}^{′} ] * {p}_{1} + [ ( {ba}^{′} - {F}_{t} ) / {aa}^{′} ] = 0 & ( 3.1 ) \\ {p}_{2}^{2} + [ ( {ab}^{′} + {ba}^{′} ) / {aa}^{′} ] * {p}_{2} + [ ( {ba}^{′} - {F}_{t} ) / {aa}^{′} ] = 0 & ( 3.2 )\end{matrix}$$

Use equations (3.1) and (3.2), at given Fₜ(max), to determine best and matching parameters p₁and p₂:
p₁=f[Fₜ(max)] and p₂=f[Fₜ(max)]
or run Fₜ equations (below), with given quality parameters of incoming material, to find matching parameters at maximized yield:

$$\begin{matrix}{F}_{t} = {aa}^{′} * {p}_{1}^{2} + [ {ab}^{′} + {ba}^{′} ] * {p}_{1} + {bb}^{′} & ( 3.3 ) \\ {F}_{t} = {aa}^{′} * {p}_{2}^{2} + [ {ab}^{′} + {ba}^{′} ] * {p}_{2} + {bb}^{′} & ( 3.4 )\end{matrix}$$

If Fₜ out of equations (3.3) and (3.4) match and yield is [symbol] yield (min) deliver parts serial numbers for pull, additional search for highest yield result at matching performance.

Compare final equations to get matching yield result (m_{y})!

The quadratic equations for p₁ are:

$$\begin{matrix}{p}_{1} ( 1 ) = [ sqrt ( xx ) - {ab}^{′} - {ba}^{′} ] / ( 2 {aa}^{′} ) \\ {p}_{1} ( 2 ) = [ sqrt ( xx ) + {ab}^{′} + {ba}^{′} ] / ( 2 {aa}^{′} )\end{matrix} \} \begin{matrix}\text{the input parameters} \\ \text{are only the} \\ \text{functional values for} \\ \text{the parameters like} \\ \text{the intercepts and} \\ \text{the slopes as well} \\ \text{as the yield} \\ \text{functions from} \\ \text{history data} \\ \text{evaluation}\end{matrix} \qquad ( 3.5 )$$

Parameter now can be used, based on serialization, to determine related component in the hub of warehouse.

While the square root is determined as:
(xx)=a²b′²+b²a′²+(2bb′−4ba′+4Fₜ)aa′

The aforementioned formulas enable the calculation of parameter 1 that matches a given parameter 2. The calculation is rather complex and only based on numbers determined using function and correlation calculations. Therefore the second method, outlined below, is preferred because of the use of measured parameters and not calculated values reflecting only means and no ranges.

3.1 Second Method Using Real Data (Less Complicated)

It is also possible to use only one of the parameters and project a given predicted yield to the second parameter to determine the required matching component performance. This method requires the history data to determine for parameter 1 the predicted yield and project the calculated yield on parameter 2 to determine the related parameter using a reversed calculation compared to the yield prediction. This implies that the function for parameter 2 is used with the predicted yield from parameter 1 to determine matching parameter 2. Raw data of two correlating parameters reflects a common yield which basically unifies the two components and parameters, due to the functional interference.

Correlating parameters certainly have a combined yield reflected in a 3D plot. Raw data functions projected on the x-z and y-z surfaces are used to determine from one parameter the “best” correlating second parameter, to find matching parts.

This is the preferred method to determine improved and matching components/parameters.

Parameter 2 is given and is provided with a certain yield predicted. Parameter 1 causes a yield drop. Therefore component 1 and respective parameter 1 are determined matching with predicted yield for parameter 2.

$${Yield}_{2} = {a}_{2} * {p}_{2} + {b}_{2} \\ {p}_{1} = [ {yield}_{2} - {b}_{1} ] / {a}_{1} \to \text{from:} {Yield}_{1} = {a}_{1} * {p}_{1} + {b}_{1} \qquad ( 3.6 )$$

Having the required parameter 1 evaluated, based on the yield/quality requirement, the system is able to search for the matching and appropriate component in the available inventory or hub, based on the serialization and full traceability capability. This is based on the fact, that SQUIT does have all quality data from the supplier available.

$$SQUIT search \text{:}$$

$$parameter 1 \to \text{part serial number for component 1}$$

According to the part serial number(s), the appropriate component can be extracted from warehouse, hub, and the like, using the existing ERP system.

The effectiveness of the module is checked by comparing the real yield numbers of the individual components, if serialized, or the lots with the predicted yield numbers out of the dedicated pull algorithm. The reliability check and proof of functionality are shown in section 7.2 and calculated using formula 7.2.

4. Spec Validation Analysis Using History Data

Check the history data due to variation from the mean spec value and correlate it to the yield. Verify for increasing variation from the mean spec value versus the yield change, to determine the dependency function. Yield is defined as a function of the component quality parameter.

$$\begin{matrix}\text{Yield:} y = F ( p ) & ( 4.1 ) \\ y = a * \underline{p} + b = a * ( \underline{x} - p ) + b & \\ F ( p ) = {\sum }_{i = 1}^{n} a ( {p}_{i} ) * ( \underline{x} - {p}_{i} ) + b ( {p}_{i} ) & \\ a ( {p}_{1} ) = [ F ( {p}_{1} ) - b ( {p}_{1} ) ] / ( \underline{x} - {p}_{1} ) \to & \\ a ( {p}_{o} ) = [ F ( {p}_{n} ) - b ( {p}_{n} ) ] / ( \underline{x} - {p}_{n} ) & \\ \underline{a} = [ {\sum }_{i = 1}^{n} a ( {p}_{i} ) ] / n & ( 4.2 )\end{matrix}$$

If slope |a|>0.05, i.e., a 5% change in yield, the yield is certainly sensitive to parameter changes, which means, that the spec limits have to be tight enough to ensure quality. The trend analysis requirement is now described hereinafter.

The “If” criteria is as follows:
If |a|>0.025, the spec limits should be kept tight to secure high quality on incoming.
If |a|>0.01, and <0.025 a decision is made individually, depending on how critical the parameter is.
If |a|<0.01, the spec must be not kept in a tight mode.

The parameter/yield function slope is also deemed a measure of sensitivity of the parameter towards spec validation. The steeper the slope, the stronger the parameter changes with variation. Therefore, it may be considered to have the slope used as an additional weighting, for better sensitivity level, and susceptibility of the parameters to changes.
y=a*p+b

The slope a is then used as a measure of sensitivity, i.e., change of parameter due to slope. The higher the slope the higher the parameter variation and the higher the probability to exceed control, warning or even spec limit at the parameter and yield side.

Spec validation must be weighted incorporating the correlation value between parameter and yield. The weighting determines if the parameter is significant to the final yield and functionality or lack thereof. Low significances enable off spec approval, while high significance requires more detailed evaluation and basically does not judge for off spec approval.

Are the 3σ ranges still within spec limit (for its calculation, use history).

Does data show too many fluctuations or too large range (for its calculation, use history)? Prioritize parameters due to yield correlation and list due to spec significance (calculation using history).

$$\{ {[ USL - LSL ]}_{i} / [ {p}_{i} ( max ) - {p}_{i} ( min ) ] \} * {CF}_{i} \geq 0.5 \\ \{ {[ USL - LSL ]}_{i} / [ 6 * {σ}_{i} ] \} * {CF}_{i} \geq 0.5 \qquad ( 4.3 )$$

It is required that the weighted comparison between spec range and parameter range as well as 6σ range be better than 50% in order to be able to consider off spec approval or spec widening. This expectation limit of 50% might chance with requirements, products, EC levels, due to learning adjustment, and the like.

If the parameter trend of mean shift has significance in yield, the spec limit must be kept tight or even tightened. Otherwise, an off spec approval can be considered. Using the correlation value (parameter versus yield) it is even possible to make a certain risk assessment of the spec validation. The parameter mean shift or trend projection can be used to determine the yield impact (yield prediction with equation 1.2) this feedback gives enough input if the underlying spec limit id appropriate or not.

5. Early Warning Analysis Based on Yield Forecast and History Data

Early warning is required for violations of:
Spec*
Target*
trend
mean shift
distribution width
etc. . . .

*Spec and target analysis is checked against a given limit only, meaning the limits are either in the SQUIT data warehouse or linked to, in case a separate warehouse exists.

5.1 Trend Analysis

Apply linear regression for recent data points (1 . . . n) and compare to history. This means an amount of data points (moving window) to be checked must be chosen. Check for slopes:

$$F ( p ) = {\sum }_{i = 1}^{n} a ( {p}_{i} ) * \vert \underline{x} - {p}_{i} \vert + b ( {p}_{i} ) \\ a ( {p}_{1} ) = [ F ( {p}_{1} ) - b ( {p}_{1} ) ] / \vert \underline{x} - {p}_{1} \vert \to \\ a ( {p}_{n} ) = [ F ( {p}_{n} ) - b ( {p}_{n} ) ] / \vert \underline{x} - {p}_{n} \vert \\ \underline{a} = [ {\sum }_{i = 1}^{n} a ( {p}_{i} ) ] / n \qquad ( 5.1 )$$

set n, parameter amount, to analyze current trend. Default set up is a moving average of the last 10 data points reported for trend analysis, applying the rules below.
If a(p)>0 and <0.01 continue and wait for next data set
If a(p)>0.01 and <0.025 notify and ask for decision
If a(p)>0.025 put parts on hold and send notifications for further analysis and CA

Compare trends on the different lots (lot to lot analysis):
Slope analysis: a(lot₁) vs a(lot₂) vs . . . vs a(lotₙ)
   5.2 Mean Shift

Compare the new population to the history and lot-to-lot comparison to history. Analysis has to use yield prediction, equation (1.2) to find the averaged mean shift.

$$Δ = ( {p}_{i} - \underline{x} ) / \underline{x} \to Δ = [ {\sum }_{i = 1}^{n} ( {p}_{i} - \underline{x} ) / \underline{x} ] / n \qquad ( 5.2 )$$

If Δ≧5% or if Δ≦−5% send warning notification and put parts on hold

To realize an effective mean shift analysis it is necessary to perform moving the window evaluation, in a backward mode from the newest parameters to the history data based on a time scale plot. As described in 5.1, the moving average stands by default at 10 for the most current parameter points, applying the rule above. It is also possible to set the number of parameters to investigate for a mean shift.

5.3 Distribution Width and Outliers

Compare the new population to the history and lot-to-lot comparison to history. Analysis has to use yield prediction, equation (1.2).

$$Δ σ = ( {σ}_{i} - \underline{σ} ) / \underline{σ} \to {Δ}_{σ} [ {\sum }_{i = 1}^{n} ( {σ}_{i} - \underline{σ} ) / \underline{σ} ] / n \qquad ( 5.3 )$$

If Δσ>5% or if Δσ≦−5% send warning notification and put parts on hold?

Using the distribution formula for the specific parameter d(p), the module determines the distribution shape, outliers, 6σ range etc.

The outliers by the full range analysis using the min/max parameters in the entire distribution are determined. A shape analysis is necessary to determine if the distribution is not normal, like bi-modal etc., by looking at the count maxima and minima across the entire parameter range.

6. Trend Analysis Based on WE (Western Electric) Rules

Incoming data is scanned for the regular SPC rules to have an early warning if incoming parameter show any trend indicating that the supplier process is running out of control or at least shows deviations which should controlled closely. The rules are:
7 consecutive points on one side of the average
7 interval of points consistently increasing or decreasing
single data point above or below control limit
single data point above or below warning limit
single data point above or below spec limit
x-bar plot exceeds control, warning or spec limit

Control limits as well as warning limits are typically defined at levels of 1, 2 or 3σ, which are determined from the history data. The underlying algorithm is simple in as much as the basic statistical equations are used, e.g., in the case where in a trend analysis, the algorithm might be as follows:

Check last 7 data points, which are summarized data, representing shipment lots and not single components. The trend is been analyzed using linear regression as:

$$Y = {\sum }_{i = n - 7}^{n} [ a * pi + b ]$$

If a >5% or <−5%, then notification is issued.

In case of mean shift, or 7 consecutive summarized data points above mean:

$$\underline{p} = [ {\sum }_{i = n - 7}^{n} pi ] / n$$

If p>x or p<x notification is issued.

7. Yield Analysis Based on History Data, to Support Preventive FA. etc.

It is used to run also a feedback loop, to determine the accuracy and reliability of the yield prediction as well as the spec analysis, to be able to apply correction, in case of deviation. Validation check for yield prediction, spec validation, dedicated pull and early warning requires traceability of the parts or at least the lot.

The feature is used as a feedback loop for validation checks on:
Yield prediction
Dedicated material pull
Early warning
Spec validation analysis

The feedback loop verifies the analysis outcomes of above listed advanced features (see flow in section 1 and 8). The feature allows a measure of the system reliability.

7.1 Predicted Yield Analysis Verification

The feedback loop uses the predicted yield (yₚ), equation (1.2) of a previous evaluated lot, using either lot (x) or even part serial numbers (z). Comparison is made versus the real production yield (yᵣ) with the same lot or part serial numbers. Comparison is performed using a correlation between yₚ and yᵣ or even by applying simply delta analysis (Δ), using all related components (n) in the shipped lot.

$$\text{Predicted yield data:} {y}_{p} ( x , z ) \\ \text{Process yield data:} {y}_{r} ( x , z ) \\ Δ = [ {\sum }_{i = 1}^{n} \vert {y}_{pi} ( x , z ) - {y}_{ri} ( x , z ) \vert ] / n \qquad ( 7.1 )$$

The average yield delta, determined between predicted and real yield, shouldn't exceed 2%. If the delta is larger, than a correction is to be applied using the transformation factor within the yield prediction analysis.

The yield prediction formula is adjusted as a function of the deviation between predicted and real yield. In case of a trend detected between the predicted and real yield, i.e., both functions show divergence, the close feedback loop determines the necessary correction step for the yield prediction formula to get back on target.

The trend analysis shows if the predicted yield diverges from real yield over time, i.e., if the deviation shows an up or down trend. In case of a trend being observed, the predicted yield calculation must be corrected as soon as the deviation limit is exceeded. To prevent fluctuations, a certain range (warning limit) is defined within the deviation limit, where a slight correction is applied as a preventative measure. In case of a high trend, a large correction is applied.

Examples are provided for a trend towards USL (upper spec limit), while the control loop is also valid for the LSL (lower spec limit) range.

Correction Steps

Each step, where a correction is applied, there is a check whether the step size is appropriate. Corrections make only sense if the deviation between prediction and reality shows a trend versus time. The correction is compared against the theoretical correction curve. In case of significant deviations (up or down), the correction is adjusted to the same order of the deviation. As long as the real correction step (curve) follows, the theoretical steps (curve) remain until the prediction remains within the deviation limit.

$$\text{Theoretical parameters:} {p}_{t} ( x , z )$$

$$\text{Corrected parameters:} {p}_{c} ( x , z )$$

$$Δ = ( {\sum }_{i = 1}^{n} [ {p}_{ti} ( x , z ) - {p}_{ci} ( x , z ) ] ) / n$$

If Δ≧25% or if Δ≦−25% use the averaged deviation (Δ). If pₜ's below p_{c}'s increase the correction step size by Δ. If pₜ's above p_{c}'s decrease the correction step size by Δ.

7.2 Dedicated Material Pull

Use the dedicated pull analysis result (m_{y}), equation (2.5) to check the predicted improved yield (yᵢ) for the matching yield analysis concerning the extracted lot (x) or parts (z). This is based on the yield forecast for dedicated material pull versus non-dedicated pull. Comparison is made versus the real production yield (yᵣ) with the same lot or part serial numbers.

Out of Analysis Prediction for Improved Yield: Process Yield Data:

(Dedicated parts with improvement range based on matching requirements)

$${y}_{ip} ( x , z ) \\ {y}_{r} ( x , z ) \\ Δ = [ {\sum }_{i = 1}^{n} \vert {y}_{ip} ( x , z ) - {y}_{ri} ( x , z ) \vert ] / n \qquad ( 7.2 )$$

The average yield delta, determined between improved yield through dedicated pull and real yield, should not exceed 2%. If delta is larger, than a correction is to be applied using the transformation factor within the yield prediction analysis.

The dedicated pull based on matching yield, the minimized yield impact, and the improved functional performance are significant features.

In case the dedicated pull show too much deviation, or a better trend between the process and the predicted yield, the algorithm must be adjusted using the same close control loop steps as described in section 7.1.

7.3 Early Warning

Use the yield prediction (yₚ) analysis versus the real yield (yᵣ). The result on early warning is either dedicated material pull or component blocking to improve the yield. Again the analysis is done for the affected lot (z) or parts (x).

$$\text{Predicted yield data:} {y}_{p} ( x , z ) \\ \text{Process yield data:} {y}_{r} ( x , z ) \\ Δ = [ {\sum }_{i = 1}^{n} {y}_{ri} ( x , z ) - {y}_{pi} ( x , z ) ] / n \qquad ( 7.3 )$$

The averaged [symbol] gives an indication for improvement due to the early warning, as long as [symbol] is a positive value. As soon as [symbol] turns to be negative early an warning must be triggered, i.e., a notification must be issued. Early warnings are also implemented in the spec validation, the trend analysis and yield prediction using the notifications in case of violations.

Close control loop steps to adjust the algorithm are described in section 7.1.

7.4 Spec Validation Analysis

After correction of the spec and implementation of the appropriate CA, the impact is studied in terms of yield improvement at the supplier (quality improvement) as well as on customer side (yield improvement), see equation (6.3).

The supplier quality (parameter versus spec) is checked to validate the improvement, compared to past. The actual parameters pᵢ, spec mean x and spec range sᵣ (3σ range) are used to determine the old and new spec/parameter deviation.

$${Δ}_{o} = [ {\sum }_{i = 1}^{n} \vert {p}_{i} - {x}_{o} - {s}_{ro} \vert ] / n \\ {Δ}_{n} = [ {\sum }_{i = 1}^{n} \vert {p}_{i} - {x}_{n} - {s}_{rn} \vert ] / n \qquad ( 7.4 )$$

Comparison between the old and new deviation gives a measure of the improvement:

$${Δ}_{t} = {Δ}_{n} / {Δ}_{o} \qquad ( 7.5 )$$

The spec validation is weighted by correlating the value between the parameter and the yield. To determine the functional significance of the parameter, also consider range and 3 to 6 σ limits against spec limits.

Close the control loop steps to adjust the algorithm are described in section 7.1.

8. Maintenance Plan Optimizer

Maintenance certainly plays a significant impact on the quality performance. If the maintenance cycles are too long, the effect is that more outliers must be manufactured, i.e., the distribution of the quality performance parameters becomes wider. The parts may show higher defect rates, wear out faster, show faster degradation and corresponding decrease in the reliability, and the like.

A simple technique monitors the quality performance versus the maintenance cycle on the time scale. High traceability down to the manufacturing equipment is required to achieve a consistent feedback on the quality performance versus the dedicated process tooling. Monitoring is realized by using a specified clip level for the fitted yield function, to drop over time and tool maintenance below a certain level.

The quality performance is then plotted against the maintenance cycle and the degradation is determined, if it exists within the single maintenance windows. If the average data degradation is significant, then the maintenance cycle must be improved (shortened).

The PM (preventive maintenance) cycles (1-c) define the range of evaluation. The slope within the cycle is determined to check if the quality is falling significantly.

$$y = {\sum }_{i = 1}^{c} a * {p}_{i} + b \to \\ \text{function analysis gives the slope for the function}$$

If the slope analysis shows that the slope is <5% (to be defined finally after learning period) the PM cycles have to be adjusted to shorter cycle range to improve the outgoing quality.

9. Yield Prediction Reliability Based on the Data Variation

The standard deviation of the measured supplier data reflects already the uncertainty of the yield to predict. This chapter handles the uncertainty of the yield prediction based on the quality data variation. Prediction reliability is secured by a close feedback loop and controlled correction using a PID type of regulation.

The deviation analysis within the close feedback determines if there is a trend in up or down direction between real and predicted yield. Concerning this input, the close feedback is correcting the prediction algorithm with large or small proportional steps to close in on target appropriate. Simple fluctuations from measurement to measurement point are monitored but are not used for correction.

Calculating a model using a parameter range and a standard deviation to determine the prediction uncertainty of the predicted yield, basically gives the expectation range.

For the prediction uncertainty based on the parameter variation it is valid to simply use the actual standard deviation of the measured parameter distribution. This means in terms of formula, that we have to use a ±3σ range.

$$\text{Predicted yield range:} {y}_{p} ( range ) = {y}_{p} \pm 3 σ \qquad ( 9.1 )$$

10. SOUIT Data Mining Module

This module contains standard statistical algorithm to determine correlation factors between at least two or more parameter columns. Furthermore the module enables the determination of the function resulting from the parameter column as well as the related offset and slope parameters. All parameters must be stored in dedicated DB table space for further usage with the advanced algorithm module (see above).

10.1 Correlation Factors

The correlation factor or value, between parameter and yield, is a measure how much the yield is dependent on this parameter. This value can be used to weight different parameters appropriate in case they determine one common yield. It is required to have sufficient history data on the supplier quality as well as on the manufacturing process to be able to achieve significant correlation values.

$${CF}_{i} = F \{ f ( {p}_{1} ) ∷ f ( {p}_{2} ) \} \qquad ( 10.1 )$$

10.2 Parameter Function, Including Slope (aᵢ) and offset (bᵢ)

The function which is in the first order certainly a linear regression, describes the dependencies between the individual parameter and the yield (in-line or final). It can be any other function besides the linear regression. Again sufficient history data is required on supplier quality and process side.

$${f}_{t} = {\sum }_{i = 1}^{n} ( {a}_{i} * {p}_{i} + {b}_{i} ) \qquad ( 10.2 )$$

10.3 Mean Value

The mean value is summarized data showing in fast manner if the quality data is mean centered, mean shifted or shows a certain trend. Again, sufficient history data is required on supplier quality and process side.

$$\underline{x} = [ {\sum }_{i = 1}^{n} {p}_{i} ] / n \qquad ( 10.3 )$$

10.4 Standard Deviation

The standard deviation is a measure for the parameter variation as well as of the process capability and stability. Again sufficient history data is required on supplier quality and process side.

$$σ = [ {\sum }_{i = 1}^{n} \vert {p}_{i} - \underline{x} \vert ] * √ w ( x ) \qquad ( 10.4 )$$

w(x) is the probability function.

Determine requirements for the data mining module and the minimum capabilities of the calculations.

While the present invention has been described in conjunction with a specific embodiment outlined above, it is evident that many alternatives, modifications and variations will be apparent to those skilled in the art. Accordingly, the embodiment of the invention as set forth above is intended to be illustrative, not limiting. Various changes may be made without departing from the spirit and scope of the invention as defined in the following claims.

1. A method for managing quality in a production facility wherein products are manufactured using components, the method comprising the steps of:
receiving quality data for incoming components;
analyzing said received quality data on the basis of history quality data collected for prior received components and history data collected while processing prior received components in said production facility;
predicting the influence of the quality of incoming components on the yield of said production facility; and
selecting components in accordance with said prediction.

2. The method of claim 1, wherein the step of predicting said yield makes a correlation between at least one parameter of said component and the effect of said at least one parameter on said yield as determined by said history quality data.

3. The method of claim 1, wherein the step of selecting components further comprises rejecting said components whose quality data indicates a degradation of production yield above preset thresholds.

4. The method of claim 1, wherein the step of selecting components further comprises eliminating first components which quality data does not match a statistical quality distribution of second components that interact with said first components.

5. The method of claim 4, wherein logistics data is used in addition to said history quality data to identify matching ones of said second components.

6. The method of claim 1, wherein said history quality data defines quality specifications for incoming components.

7. The method of claim 1, wherein statistical data analysis is performed on parametric raw data for each of said components.

8. The method of claim 7, wherein said parametric raw data includes at least one functional, one dimensional parameter or at least one process parameter for manufacturing said product.

9. The method of claim 1, wherein history quality data triggers preventive maintenance for said production facility.

10. The method of claim 1, wherein quality data is exchanged electronically in predefined formats between said production facility and component suppliers.

11. A program storage device readable by a machine, tangibly embodying a program of instructions executable by as machine to perform method steps for managing quality in a production facility wherein products are manufactured using components, said method steps comprising:
receiving quality data for incoming components;
analyzing said received quality data on the basis of history quality data collected for prior received components and history data collected during processing of prior received components of said production facility;
predicting the influence of the quality of incoming components on the yield of said production facility; and
selecting components in accordance with said prediction.

12. A computer system for managing quality in a production facility where products are manufactured using components, said computer system comprising:
means for receiving quality data for incoming components;
means for analyzing said received quality data on the basis of history quality data collected for prior received components and history data collected during processing of prior received components in said production facility;
means for predicting the influence of the quality of incoming components on the yield of said production facility; and
means for selecting components in accordance with said prediction.

13. The computer system of claim 12, wherein said means for predicting yield comprises means for correlating at least one parameter of a component with the effect of that parameter on the yield as described by history data.

14. The system of claim 11, wherein said selecting means comprises means for rejecting components whose quality data indicates a degradation of production yield above preset thresholds.

15. The system of claim 11, wherein said selecting means comprises means for eliminating first components whose quality data does not match a statistical quality distribution of second components that interact with said first components.

16. The system of claim 11, wherein means provide the history of quality data for triggering preventive maintenance for said production facility.

17. The system of claim 11, wherein means are provided to exchange quality data electronically in predefined formats between said production facility and suppliers of components.
